(19) United States
(12) Patent Application Publication
(10) Pub. No.: US 2014/0152028 A1
(43) Pub. Date: Jun. 5, 2014

(54) LOCK CROSS MEMBER AND HOOD LOCK FOR A MOTOR VEHICLE

(71) Applicant: GM GLOBAL TECHNOLOGY OPERATIONS LLC, Detroit, MI (US)

(72) Inventors: Steffen Karl LESCHNIK, Bad Schwalbach (DE); Joerg FUGE, Worms (DE)

(73) Assignee: GM GLOBAL TECHNOLOGY OPERATIONS LLC, Detroit, MI (US)

(21) Appl. No.: 14/090,338

(22) Filed: Nov. 26, 2013

(30) Foreign Application Priority Data
Nov. 26, 2012 (DE) 10 2012 023 020.6

(51) Int. Cl. E05C 3/12; B62D 25/08

(52) U.S. Cl. CPC E05C 3/12; B62D 25/082
USPC 292/337

(57) ABSTRACT

A lock cross member is provided for a motor vehicle with a receptacle area for accommodating a hood lock. The lock cross member is a hollow profile, and the receptacle area is displaced into the interior of the lock cross member. A hood lock is also provided for installation on a lock cross member. In addition, a module is provided for a motor vehicle with a lock cross member and a hood lock mounted thereon.

### CROSS-REFERENCE TO RELATED APPLICATION

This application claims priority to German Patent Application No. 10 2012 023 020.6, filed Nov. 26, 2012, which is incorporated herein by reference in its entirety.

### TECHNICAL FIELD

The technical field relates to a lock cross member for a motor vehicle, with a receptacle area for accommodating a hood lock, and further relates to a hood lock for installation on such a lock cross member.

### BACKGROUND

Motor vehicles usually exhibit a hood lock, with which the vehicle hood pivoted to the vehicle body can be locked in the closed state. To this end, the hood lock exhibits an unlocking device, the unlocking mechanism of which ensures that the hood is durably locked against the vehicle body on the one hand, and allows the hood to be unlocked at any time so that it can be opened as needed on the other. In light of its unlocking device, the hood lock is structurally relatively expansive, so that the motor vehicles exhibit a relatively large front overhang to provide enough installation space for accommodating the hood lock.

Therefore, at least one object is to further develop a lock cross member and hood lock with the features mentioned at the outset in such a way that the hood lock can be compactly integrated onto the lock cross member. In addition, other objects, desirable features and characteristics will become apparent from the subsequent summary and detailed description, and the appended claims, taken in conjunction with the accompanying drawings and this background.

### SUMMARY

A lock cross member is provided for a motor vehicle has a receptacle area for accommodating a hood lock. The lock cross member is designed as a hollow profile, and the receptacle area is displaced into the interior of the lock cross member. Therefore, displacing the receptacle area accommodates a hood lock at least partially into the interior of the lock cross member, so that the hood lock can be integrated at least partially into the interior of the lock cross member. As a result, the hood lock can be compactly integrated onto the lock cross member.

Because of the lock cross member, a hood lock mounted thereto takes up relatively little installation space, so that the front overhang of a motor vehicle can be kept relatively small. A smaller front overhang facilitates the realization of structurally more compact motor vehicles. As a whole, this also makes it easier to reduce the vehicle weight. In addition, the installation space at the front of the vehicle is better utilized, without losing installation space inside the engine compartment. Because the hood lock can be situated or is situated at least partially inside the lock cross member, the hood lock is at least partially or completely removed from the pedestrian protection area serving as the deformation space, specifically the upper leg region.

The lock cross member further enables an improved classification in terms of the type insurance classification (TIC), since a rearward displacement is achieved for the separation between the hood and bumper. A simple assembly of the hood lock to the lock cross member is ensured if the lock cross member in one embodiment of the invention exhibits at least one opening through which a hood lock can be brought into the receptacle area lying in the interior of the lock cross member from outside, in particular from one of the longitudinal sides of the lock cross member.

The opening should extend at least until into a wall section, which forms an upper wall section with the lock cross member installed, so that at least one locking element or unlocking element of the unlocking device of the hood lock outwardly protrudes from it, or at least can outwardly protrude from it. As a result, the opening on the one hand serves to incorporate the hood lock, and on the other as a passage for a functional part of the unlocking device, so as to ensure that the hood locks or unlocks. For example, the locking element or unlocking element can be formed by at least one arrester hook, which then projects out of the upwardly facing wall section of the lock cross member.

It makes sense for the opening to be designed as a square, in particular a rectangle. This makes the opening easy to realize from a geometric standpoint. In addition, the opening is thereby essentially adjusted to the contour of the dimensions for the hood lock, so that the hood lock can be easily passed through the opening, so as to be mounted on the receptacle area of the lock cross member.

An embodiment provides that the opening extend over the corner area of two wall sections of the outer peripheral wall of the lock cross member that are arranged at an angle relative to each other. This facilitates the assembly of the hood lock on the lock cross member, since the opening extending over the corner area exposes the receptacle area on the lock for the hood lock to an especially large extent. This avoids a costly and complicated threading of the hood lock through the opening.

Another embodiment provides that the opening extend over the corner area of two wall sections of the outer peripheral wall of the lock cross member that are arranged at an angle relative to each other, of which one wall section is forwardly facing, and the other wall section is upwardly facing, with the lock cross member built in. As a consequence, the forwardly facing wall section forms a front wall section, and the upwardly facing wall section forms an upper wall section. As a result, the advantages already mentioned are achieved on the one hand. At the same time, the upper wall section and the part of the opening extending up to that point yield a passage for functional parts of the unlocking device of the hood lock. For example, the at least one unlocking element or locking element of the unlocking device can be exposed through this passage, so as to ensure that the hood is optimally locked or unlocked on the vehicle body.

Another embodiment provides that at least one, preferably two attachment points for positively and/or non-positively securing the hood lock be furnished on the boundary of the opening, in particular the outlying boundary of the opening. As a result, the hood lock can be secured to the lock cross member in a technically easy manner In another embodiment, forming the attachment points on wall sections that face forward with the lock cross member built in provides a technician with especially good accessibility.

In order to secure the hood lock to the lock cross member as well as possible, another embodiment provides that the attachment points be spaced apart from each other, so that the hood lock can be arranged or is arranged in between the latter. The attachment points can be formed by a respective passage opening, on which a respective nut, in particular a weld nut, can be arranged or is arranged so as to secure the hood lock to the lock cross member through bolting. It is also conceivable for the area of the attachment points of the lock cross member to exhibit a material thickening, in which a thread is incorporated, so that the hood lock can be secured to the lock cross member by screwing a connecting element into the respective material thickening.

The attachment points can also be designed for materially securing the hood lock to the wall section. It is also conceivable for the attachment points to be designed for a combined positive, non-positive and/or material securing of the hood lock to the wall section. As an alternative to the attachment points furnished on the outlying boundary of the opening, another embodiment of the invention can provide that at least one, preferably two attachment sites be present for positively and/or non-positively securing the hood lock to a wall section, which forms a rear wall section with the lock cross member built in. This enables an especially structurally compact accommodation of the hood lock on the lock cross member, since because the hood lock is attached to the rear lateral wall of the lock cross member, it can be incorporated inside the lock cross member without an overhang forwardly projecting out of the lock cross member. As a consequence, this attachment to the rear lateral wall of the lock cross member makes it possible to accommodate the hood lock between the front lateral wall and the rear lateral wall of the lock cross member.

To enable an easy assembly and disassembly of the hood lock given such an integrated installation of the hood lock on the lock cross member, another embodiment of the invention provides for at least one assembly opening on a wall section, making it possible to reach the at least one attachment point, for example by means of a tool. The accessibility to the attachment point from outside can be further improved given the ability to reach the at least one attachment point from outside, for example with a tool, by having the wall section with the at least one assembly opening face forwardly with the lock cross member built in. This enables accessibility from outside.

In another embodiment, the attachment points can be made particularly easy for a technician to reach by providing a respective assembly opening for each attachment point, i.e., by allocating a respective assembly opening to each attachment point. In another embodiment of the invention, the lock cross member exhibits a monocoque structure made up of at least two profile parts joined together. As a result, the lock cross member can be realized with sufficient rigidity in a lightweight design.

It makes sense for one of the profile parts to exhibit an opening or the opening described above, through which a hood lock can be brought into the receptacle area lying in the interior from outside. This makes the lock cross member technically easy to realize, since the opening need only be formed on one of the two profiles.

An embodiment provides that the profile part exhibiting the opening and the other profile part each essentially be L-shaped in design. One of the profile parts preferably exhibits at least one material section or flange section that adjoins the L-shape, in particular protruding outwardly, for attachment with the other profile part, which at least partially extends over the length of the profile part. This yields a lock cross member that can be secured to the vehicle body on a rearward facing, horizontal carrier section, and on a frontally situated, essentially vertical carrier section.

Another embodiment provides that the profile part exhibiting the opening be essentially U-shaped in design, with the other profile section being situated between the legs, preferably accompanied by the formation of a cavity that comprises the receptacle area for the hood lock. The U-shaped configuration of the profile part causes the ends of the legs to essentially face in the same direction with the lock cross member built in, preferably extending from the front toward the back, and essentially lying in a horizontal position, thereby offering another or alternative option for installation on the vehicle body.

It makes sense for the other profile part to also be U-shaped in design, its legs serve as a flange for attachment with the profile part exhibiting the opening, which for this purpose are connected against the leg of the profile part exhibiting the opening in the area of its free end. The hood lock for installation on a lock cross member of the kind described above has a bracket that carries a locking/unlocking device, and is provided with at least two laterally and outwardly protruding material sections for securing the hood lock to the lock cross member of the kind described above.

An embodiment provides that the material sections and bracket lie essentially in a shared plane, in particular form a shared plate element. Such a hood lock is suitable in particular for installation on a lock cross member whose attachment points for the hood lock are situated on the outlying boundary of the opening. As a result, the bracket or bracket plate of the hood lock in conjunction with the outwardly protruding material sections forms an outer border of the lock cross member. The material sections of the hood lock abut from outside against the forwardly facing lateral wall of the lock cross member, and, for example, are joined with the attachment point of the lock cross member lying behind via at least one through hole in the respective material section.

An alternative embodiment provides that the material sections form a plane, which is spaced apart from a plane formed by the bracket, so that the locking/unlocking device can be situated or is situated between the planes. Such a hood lock can advantageously be installed on a lock cross member, whose attachment points for positively and/or non-positively securing the hood lock to the lock cross member are arranged on a wall section that forms a rear wall section with the lock cross member built in. As a consequence, the material sections of the hood lock serving as a flange can be made to abut against the rear lateral wall of the lock cross section and fixed in place thereon. The bracket itself or the bracket with the components of the locking/unlocking device integrated thereon faces toward the forwardly facing lateral wall of the lock cross member when the lock cross member has been mounted on the vehicle body. As a result, this embodiment of the hood lock is especially well suited for such an embodiment of the lock cross member whose receptacle area for the hood lock enables a complete accommodation of the hood lock between the front and rear lateral wall of the lock cross member. A further embodiment provides that the hood lock exhibit at least one, preferably several stiffening sections, in particular stiffening collars, for example which are turned toward the opening of the lock cross member in the area of the boundary, and serve to improve the structural rigidity of the lock cross member.

A module is provided for a motor vehicle with a lock cross member of the kind described above and a hood lock of the kind described above mounted thereon. A lock cross member is provided for a motor vehicle having a monocoque construction, for example, designed with two L-profiles joined together. The profile situated at the front in the built-in state is preferably provided with an oblong hole having a collar to accommodate a hood lock inside. The hood lock can be screwed on via the front side of the lock cross member by way of two bolting points. The lock housing is preferably designed in such a way that it can handle the functions and components for primary and secondary unlocking, for example the arrester hooks. The structural rigidity of the lock cross member can be elevated by selectively configuring the lock housing and attaching stiffening collars in the area of the edge of the oblong hole.

### BRIEF DESCRIPTION OF THE DRAWINGS

The present invention will hereinafter be described in conjunction with the following drawing figures, wherein like numerals denote like elements, and:

FIG. 1 is a perspective view depicting a possible embodiment of a lock cross member for a motor vehicle along with a possible embodiment of a hood lock mounted thereon;

FIG. 2 is a sectional view depicting the arrangement of the lock cross member and hood lock according to FIG. 1;

FIG. 3 is a perspective view depicting the hood lock according to FIG. 1;

FIG. 4 is a perspective view depicting the bracket of the hood lock according to FIG. 1;

FIG. 5 is a perspective view depicting another possible embodiment of a lock cross member with a possible embodiment of a hood lock mounted thereon;

FIG. 6 is a sectional view depicting the arrangement of the lock cross member and hood lock according to FIG. 5;

FIG. 7 is a perspective view depicting another possible embodiment of a lock cross member along with a possible embodiment of a hood lock mounted thereon;

FIG. 8 is a sectional view depicting the arrangement of the lock cross member and hood lock according to FIG. 7;

FIG. 9 is a perspective view depicting yet another possible embodiment of a lock cross member along with a possible embodiment of a hood lock mounted thereon; and

FIG. 10 is a sectional view depicting the arrangement of the lock cross member and hood lock according to FIG. 9.

### DETAILED DESCRIPTION

The following detailed description is merely exemplary in nature and is not intended to limit application and uses. Furthermore, there is no intention to be bound by any theory presented in the preceding background or summary or the following detailed description.

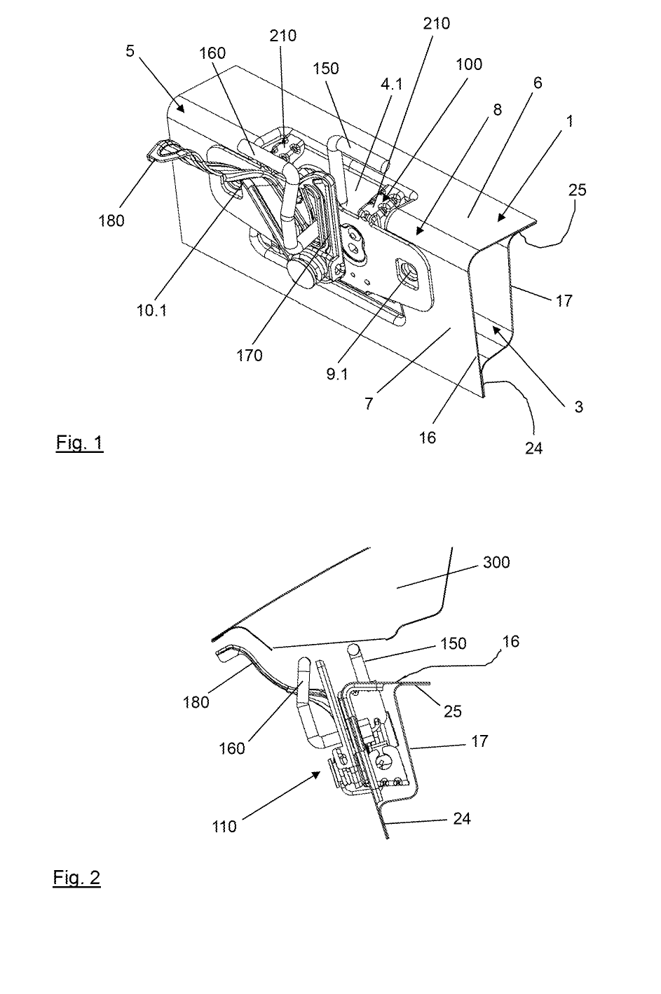

FIG. 1 presents a schematic view depicting an embodiment of a lock cross member 1 and an embodiment of a hood lock 100, which is mounted on the lock cross member 1. The lock cross member 1 and the hood lock 100 are each depicted in a perspective view. The lock cross member 1 is only shown in the area of the hood lock 100. To provide a better understanding, FIG. 2 presents a sectional view depicting the arrangement of the lock cross member 1 and hood lock 100 as a cross section through the lock cross member 1. FIG. 2 shows a cutout of the hood 300 in the closed state, i.e., resting on the hood lock 100.

As evident from FIG. 1 and FIG. 2, the lock cross member 1 is designed as a hollow profile, and provided with an opening 4.1 through which the hood lock 100 is integrated in the interior 3 of the lock cross member 1 from outside. As a consequence, the hood lock 100 is largely displaced into the interior 3 of the lock cross member, so that the hood lock 100 essentially utilizes the installation space of the lock cross member 1, thereby yielding an especially compact arrangement. Only a few components of the hood lock 100, in particular the locking/unlocking device 110 of the hood lock 100, protrude or extend out of the lock cross member 1, for example the bolt elements 150 and 160, an arrester hook 170, and an actuating element 180 connected thereto, so as to open the hood 300 with the hood lock 100 in the unlocked state.

The opening 4.1 here extends over the corner area 5 of two wall sections 6 and 7 of the outer peripheral wall of the lock cross member 1 that are arranged at an angle relative to each other, and is preferably essentially rectangular in design. With the lock cross member 1 in a built-in state, the wall section 6 is preferably the upwardly facing wall section, which forms an upper wall section. With the lock cross member 1 in the built-in state, the wall section 7 is the forwardly facing wall section, which forms a front wall section of the lock cross member 1.

Two attachment points 9.1 and 10.1 are formed on the outlying boundary 8 of the opening 4.1, in particular on the wall section 7 forming the front wall section with the lock cross member 1 in the built-in state, which are used for positively, non-positively and/or materially securing the hood lock 100 to the lock cross member 1. For example, the attachment points 9.1 and 10.1 can be formed by a respective passage opening through wall section 7, for example, on whose interior side a weld nut is fixed or a nut can be applied, with which the hood lock 100 can be screwed on using a screw element. The attachment points 9.1 and 10.1 are preferably arranged on opposite sides of the boundary 8.

As further evident from FIG. 1 and FIG. 2, the lock cross member 1 has two molded parts or profile parts 16 and 17, for example which are materially joined together, in particular through welding or hard soldering. The passage opening 4.1 is formed on the profile part 16, wherein the profile part 16 is essentially L-shaped in design. The profile part 17 secured thereto is also essentially L-shaped in design. A respective flange section 24 or 25 is molded onto its cross sectionally outlying ends, and preferably extends over the respective longitudinal extension of the lock cross member 1.

In their angular position, the flange sections 24 and 25 form an abutment surface on the profile part 17 for placement against the profile part 16, specifically on the outside end area of the L-shaped profile part 16, so that the two profile parts 16 and 17 are joined together, forming the interior 3 of the lock cross member 1 designed as a cavity. At the flange sections 24 and 25, the longitudinal sides of the lock cross member 1 can be secured to a vehicle body (not shown on FIG. 1 and FIG. 2).

FIG. 3 presents a perspective view of the hood lock 100 according to FIG. 1 and FIG. 2. The bolt elements 150 and 160 visible from FIG. 1 and FIG. 2, the arrester hook 170 and the actuating element 180 have been omitted for the sake of simplicity. FIG. 3 only depicts individual components of the locking and unlocking device 110.

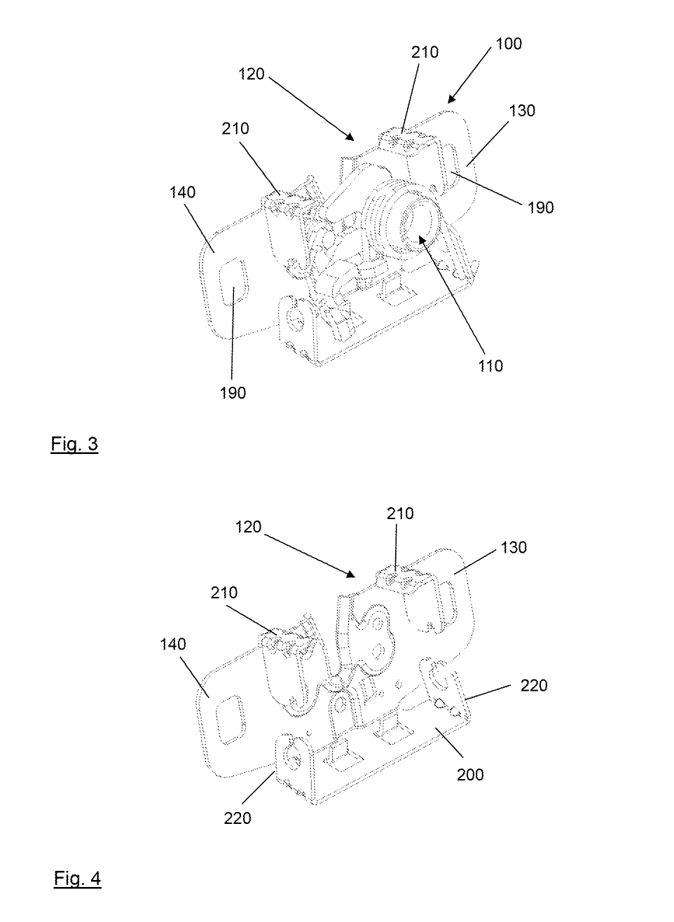

FIG. 4 also presents a perspective view according to FIG. 1 of the bracket 120 for the hood lock 100 in an isolated setup. As evident from FIG. 3 and FIG. 4, the hood lock 100 exhibits the bracket 120 for the locking and unlocking device 110, which preferably essentially is plate-shaped in design. The laterally outwardly protruding ends of the bracket 120 are provided with material sections 130 and 140, which each have a passage opening 190, wherein the bracket 120 is located between the laterally outwardly protruding material sections 130 and 140. The material sections 130 and 140 and the bracket 120 or the bracket plate essentially lie in a shared plane, and preferably form a shared plate element, for example which can be fabricated out of one piece.

An additional material section 200 can be provided on the bracket at an angle thereto, which is situated at an angle to the bracket 120 or bracket plate, in particular essentially at a right angle to the bracket 120, and used to accommodate or secure individual components of the locking or unlocking device 110. The additional material section 200 can be provided with lateral upturns 220 via joining, for example welding or soldering, or through molding, for example bending, which as a receptacle or the like can be moved or is moved into the operating position with at least one component of the locking or unlocking device 110 of the hood lock 100. The bracket 120 can further be provided with at least one, preferably several stiffening sections 210, which with the hood lock 100 in the installed state at least partially close the opening 4.1 of the lock cross member 1, and thereby improve the structural rigidity of the lock cross member 1.

As evident in particular from FIG. 1, the hood lock 100 with its material sections 130 and 140 is switched into the operating position from outside against the wall section 7, wherein the locking or unlocking device 110 essentially projects into the interior 3 of the lock cross member 1. In order to fix the hood lock 100 in place on the lock cross member 1, screw elements, for example screws, can be guided through the two passage openings 130 and 140 on the hood lock 100, and screwed into a threaded section or weld nut on the lock cross member 1 while clamping the hood lock 100 against the lock cross member 1, which is not depicted on FIG. 1 and FIG. 2.

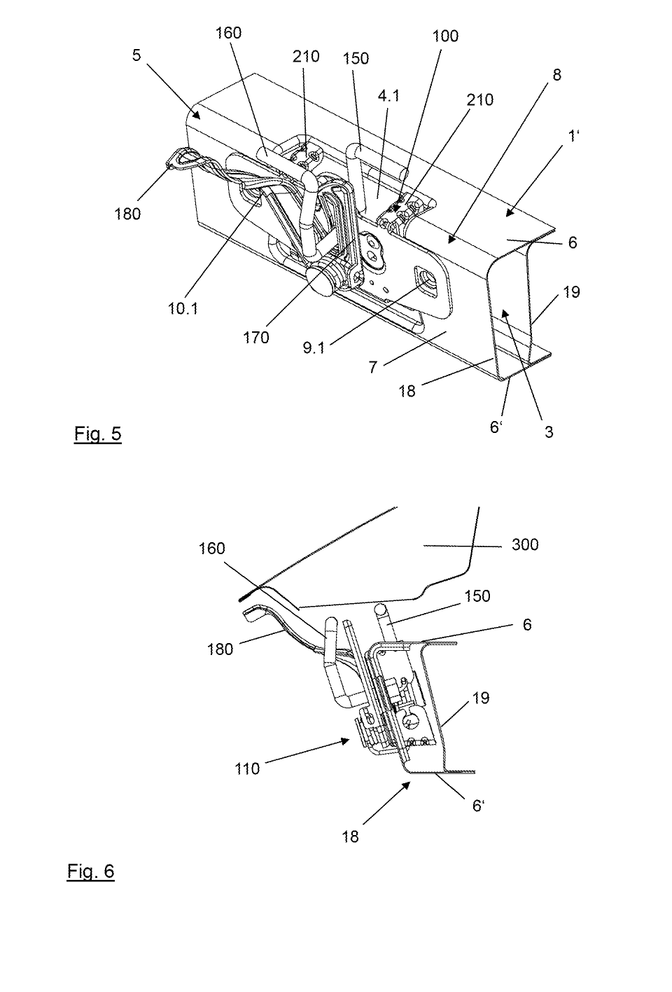

FIG. 5 and FIG. 6 show a perspective view (FIG. 5) and sectional view (FIG. 6) depicting another possible embodiment of a lock cross member 1′. As evident from FIGS. 5 and 6, the hood lock 100 on FIG. 1 and FIG. 2 can be used for installation to the lock cross member V. In this regard, reference is made to the description of the hood lock 100 according to FIG. 1 to FIG. 4.

Components of the lock cross member 1′ according to FIG. 5 and FIG. 6 that are structurally or functionally identical to components of the lock cross member 1 according to FIG. 1 to FIG. 4 are labeled with the same reference numbers; in this regard, reference is also made to the description for FIG. 1 to FIG. 4. Among other things, the lock cross member 1′ according to FIG. 5 and FIG. 6 differs from the lock cross member 1 according to FIG. 1 to FIG. 4 in that the lock cross member 1′ consists of two essentially U-shaped profile parts 18 and 19. The profile part 18 here exhibits the opening 4.1, which extends over the corner area 5 from the wall section 6 up until the wall section 7. The wall section 7 forms the floor section of the U-shaped profile part 18, and the wall section 6 preferably forms one leg of the U-shaped profile part 18. The second leg 6′ is allocated to the opposite wall section 6.

The wall sections 6 and 6′ form the legs of the U-shaped profile part 18, and at their end sections serve as a flange for the other U-shaped profile part 19, whose two legs abut against the respective end area of the wall sections 6 and 6′, and which is there connected. As a result, the floor sections of the U-shaped profile parts 18 and 19 are spaced apart from each other, thereby forming the cavity of the lock cross member 1′, which at least partially incorporates the hood lock 100.

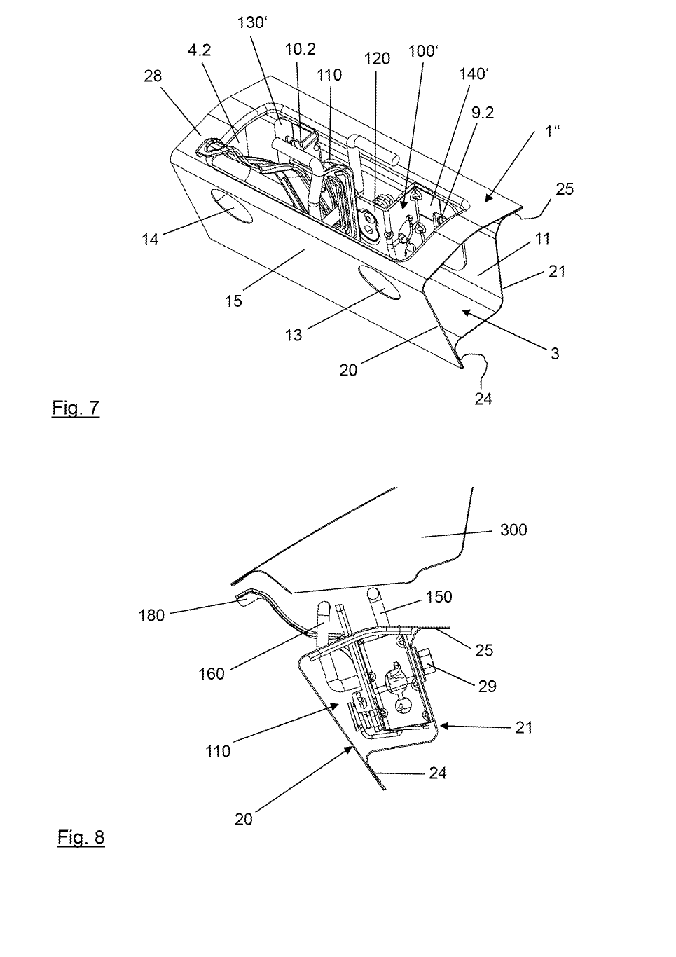

FIG. 7 and FIG. 8 show a perspective view (FIG. 7) and sectional view (FIG. 8) depicting another possible embodiment of a lock cross member 1″ with another possible embodiment of the hood lock 100′ mounted thereon. Components of the lock cross member 1″ and hood lock 100′ according to FIG. 7 and FIG. 8 that are structurally or functionally identical to components of the lock cross member 1 or 1′ according to FIG. 1 to FIG. 6 are labeled with the same reference numbers; in this regard, reference is made to the description for the lock cross member 1 according to FIG. 1 to FIG. 4 or the lock cross member 1′ according to FIG. 5 and FIG. 6. Components of the lock cross member 100′ that are structurally or functionally identical to components of the hood lock 100 according to FIG. 1 to FIG. 6 are labeled with the same reference numbers; in this regard, reference is also made to the description for FIG. 1 to FIG. 6.

Among other things, the lock cross member 1″ according to FIG. 7 and FIG. 8 differs from the lock cross members 1 and 1′ in that the lock cross member 1″ exhibits an opening 4.2, through which the hood lock 100′ can be built into the interior 3 of the lock cross member 1″ from outside. The opening 4.2 is arranged on a wall section 28 that projects upwardly with the lock cross member 1″ in the built-in state, i.e., forms an upper wall section. The opening 4.2 is preferably situated exclusively in the wall section 28.

As evident from FIG. 7 and FIG. 8, the lock cross member 1″ has two profile parts 20 and 21. Profile part 20 exhibits the wall section 28 with the opening 4.2 and a wall section 15 lying at an angle relative thereto. The profile part 20 is essentially L-shaped in design, wherein the wall section 28 is formed at one of the legs, and the wall section 15 is formed at the other leg. The other profile part 21 is also essentially L-shaped in design, wherein, adjoining the L-shape as viewed in cross section, (it is) designed at the bilateral ends of the flange sections 24 or 25 for connection with the profile part 20.

In the embodiment according to FIG. 7 and FIG. 8, the hood lock 100′ is integrated into the lock cross member 1″, arranged between the wall sections 11 and 15, and fixed against the wall section 11. In order to be able to fix the hood lock 100′ against the wall section 11, the opposite wall section 15 exhibits two assembly openings 13 and 14, which a technician can use to assemble the hood lock 100′ against the wall section 11, for example by means of a tool. In the embodiment of the lock cross member 1″ and hood lock 100′ according to FIGS. 7 and 8, the wall section 11 forming a rear wall section with the lock cross member 1″ in a built-in state is provided with attachment points 9.2, 10.2 for positively, non-positively and/or materially securing the hood lock 100′ to the wall section 11.

To this end, the hood lock 100′ exhibits outwardly projecting material sections or flange sections 130′ and 140′, between which the bracket 120 or bracket plate of the hood lock 100′ is arranged. The flange sections 130′ and 140′ form a plane spaced apart from the plane formed by the bracket 120, so that the locking/unlocking device 110 can be at least partially situated between the planes. In other words, the flange sections 130′ and 140′ are displaced toward the back relative to the bracket 120 or bracket plate in such a way with the hood lock mounted 100′ that the flange sections 130′ and 140′ come to abut against the wall section 11. The attachment points 9.2 and 10.2, for example which can be designed as a passage opening, and the passage openings 190 on the flange sections 130′ and 140′ make it possible to secure the hood lock 100′ to the lock cross member 1″ by generating a bolted connection with the wall section 11 and flange sections 130′ and 140′ interposed.

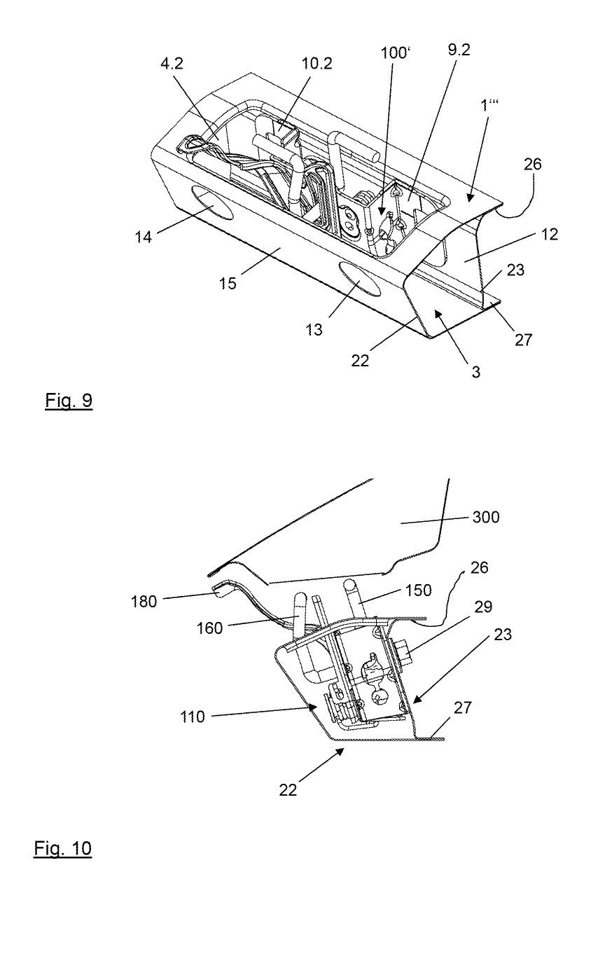

For example, as evident from FIG. 8, such a bolted connection can be established by screwing in a screw element 29 from the exterior side of the wall section 11, e.g., which is screwed into a nut element (not shown on FIG. 7 and FIG. 8) applied to the respective material section or flange section 130 and 140 through the respective assembly opening 13 or 14. FIG. 9 and FIG. 10 again show another embodiment of a lock cross member 1′″. The lock cross member 1′″ is designed to accommodate the hood lock 100′ according to FIG. 7 and FIG. 8. Of course, a differently configured hood lock can also be secured to the lock cross member 1′″.

Components of the lock cross member 1′″ according to FIG. 9 and FIG. 10 that are identical or functionally similar to components of the preceding lock cross members 1, 1′, 1″ are labeled with the same reference numbers; in this regard, reference is made to the preceding description for the lock cross members 1, 1′ and 1″. Among other things, the lock cross member 1′″ differs from the lock cross member 1″ according to FIG. 7 and FIG. 8 in that the lock cross member 1′″ has two essentially U-shaped profile parts 22 and 23, which are joined together like the profile part 20 according to FIG. 5 and FIG. 6. The hood lock 100′ is here secured to a wall section 12 that forms a rear, essentially vertical wall section with the lock cross member 1′″ built in, and is comprised of the floor section of the U-shaped profile part 23. The legs of the profile part 23 each form a flange section 26 and 27, which is made to abut against an end section of the respective leg of the profile part 22 as viewed in the cross section of profile parts 22 and 23.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A lock cross member for a motor vehicle, comprising:
a hood lock; and
a receptacle area that is configured to accommodate the hood lock,
wherein the lock cross member is a hollow profile, and
wherein the receptacle area is displaced into an interior of the lock cross member.

2. The lock cross member according to claim 1, wherein the lock cross member comprising an opening through which the hood lock is brought into the receptacle area lying in the interior from an outside.

3. The lock cross member according to claim 2, wherein the opening extends over a corner area of two wall sections of an outer peripheral wall of the lock cross member that are arranged at an angle relative to each other.

4. The lock cross member according to claim 3, wherein the opening extends over the corner area of the two wall sections of the outer peripheral wall of the lock cross member that are arranged at the angle relative to each other, of which a first wall section is forwardly facing, and a second wall section is upwardly facing with the lock cross member built in.

5. The lock cross member according to claim 2, wherein at least one attachment point is provided on a boundary of the opening for securing the hood lock.

6. The lock cross member according to claim 2 4, wherein at least one attachment point of the is provided for securing the hood lock to a wall section that forms a rear wall section with the lock cross member built in.

7. The lock cross member according to claim 6, wherein at least one assembly opening is provided on the wall section, through which the at least one attachment point is reachable, with a tool.

8. The lock cross member according to claim 1, wherein the lock cross member comprises a monocoque structure made up of a first profile part joined to a second profile part.

9. The lock cross member according to claim 8, wherein the first profile parts comprises an opening through which the hood lock is brought into the receptacle area lying in the interior from outside.

10. The lock cross member according to claim 8,
wherein the first profile part comprising an opening and the second profile part each are essentially L-shaped, and
wherein the second profile parts includes at least one outwardly protruding flange section that adjoins an L-shape for attachment with the second profile part, which extends at least partially over a length of the profile part.

11. The lock cross member according to claim 8, wherein the profile part comprising an opening is essentially U-shaped with the second profile part situated between legs.

12-15. (canceled)
